(19) United States
(12) Patent Application Publication
(10) Pub. No.: US 2024/0161082 A1
(43) Pub. Date: May 16, 2024

(54) INFORMATION PROCESSING APPARATUS AND METHOD

(71) Applicant: Toshiba Tec Kabushiki Kaisha, Tokyo (JP)

(72) Inventor: Nobutomo NODERA, Izu Shizuoka (JP)

(21) Appl. No.: 18/358,785

(22) Filed: Jul. 25, 2023

(30) Foreign Application Priority Data
Nov. 11, 2022 (JP) 2022-181030

(51) Int. Cl. G06Q 20/20; G06Q 30/0251

(52) U.S. Cl. CPC G06Q 20/209; G06Q 30/0268

(57) ABSTRACT

According to one embodiment, an information processing apparatus includes a storage unit for storing first logo data associated with commodities, a communication interface to connect to a point-of-sale terminal, and a processor. The processor is configured to acquire commodity identification information for a commodity from the point-of-sale terminal, register commodity information for the commodity in a sales transaction, select a piece of logo data from the storage unit based on the registered commodities in the sales transaction, and output the selected piece of logo data to the point-of-sale terminal for inclusion in a header portion of a transaction receipt provided by the point-of-sale terminal for the sales transaction.

### CROSS-REFERENCE TO RELATED APPLICATION

This application is based upon and claims the benefit of priority from Japanese Patent Application No. 2022-181030, filed Nov. 11, 2022, the entire contents of which are incorporated herein by reference.

### FIELD

Embodiments described herein relate generally to an information processing apparatus and a method associated with point-of-sale systems for retail stores and the like.

### BACKGROUND

A point-of-sale (POS) terminal is used in a store at which commodities or services (hereinafter, collectively referred to as “commodities”) are sold. The POS terminal executes payment processing for paying a purchase price of a commodity and causes a receipt printer to dispense a receipt for the customer. A logo such as a store name can be printed in a header portion of the printed receipt. The receipt printer generally prints the logo in the header portion of the receipt based on logo data (image data) stored in the receipt printer itself.

In the related art, a control device that updates logo data stored in a receipt printer based on a predetermined condition has been proposed. In a technique of the related art, in Christmas season or New Year season, logo data for receipt headers is updated to reflect the seasons.

However, such updated logo data is generally unrelated to any commodity actually purchased by a customer, and the effort to change the logo data is not necessarily effective for the store directly in terms of improved commodity sales. However, since the header portion is a part of the receipt that a customer is likely to pay attention to or at least view and it may be desirable for stores to make more effective use of the header portion beyond just including a logo and a store name.

### BRIEF DESCRIPTION OF THE DRAWINGS

FIG. 1 is a diagram schematically showing a POS system according to an embodiment.

FIG. 2 is a diagram showing an example of a receipt dispensed by a receipt printer.

FIG. 3 is a diagram showing another example of a receipt.

FIG. 4 is a block diagram of a server device.

FIG. 5 is a diagram showing a data configuration of a commodity information table stored in a storage unit.

FIG. 6 is a diagram showing a data configuration of a receipt planning table.

FIG. 7 is a diagram showing a data configuration of a transaction information field.

FIG. 8 is a diagram showing a data configuration of a receipt data field.

FIG. 9 is a diagram showing a data configuration of a logo data field.

FIG. 10 is a block diagram of a control unit.

FIG. 11 is a sequence chart showing an operation flow of a POS system.

FIG. 12 is a flowchart of logo ID selection processing by a control unit.

### DETAILED DESCRIPTION

According to one embodiment, an information processing apparatus for point-of-sale systems includes a storage unit for storing first logo data associated with commodities, a communication interface configured to connect to a point-of-sale terminal, and a processor. The processor is configured to acquire commodity identification information for a commodity from the point-of-sale terminal via the communication interface, register commodity information for the commodity identified by the acquired commodity identification information in a sales transaction, select a piece of first logo data from the storage unit based on the registered commodity information in the sales transaction, and output the selected piece of first logo data to the point-of-sale terminal via the communication information for inclusion in a header portion of a transaction receipt provided by the point-of-sale terminal for the sales transaction.

Hereinafter, an information processing apparatus and a method according to certain embodiments will be described with reference to the drawings. The present disclosure is not limited to the specific example embodiment described below. For example, an information processing apparatus can be a server device or a point of sale (POS) terminal, or may be implemented by a server device and a POS terminal in combination.

In the present embodiment, a receipt is a paper receipt dispensed by a receipt printer, but the present disclosure is not limited thereto. The receipt may be an electronic receipt provided by an electronic receipt server.

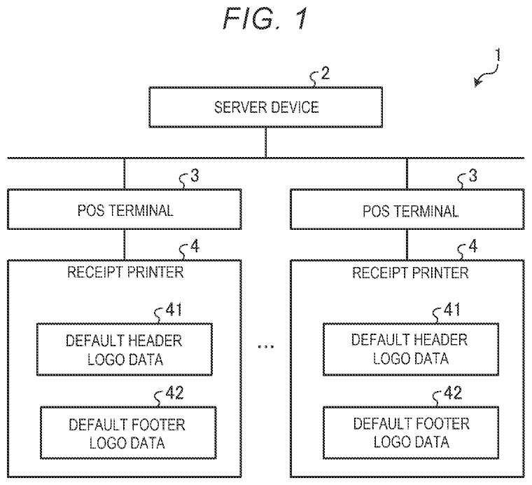

FIG. 1 is a diagram schematically showing a POS system 1 according to an embodiment. The POS system 1 is used in a store such as a supermarket. The POS system 1 includes a server device 2, POS terminals 3, and receipt printers 4. The server device 2, the POS terminal 3, and the receipt printer 4 are communicably connected to each other via a wired or wireless local area network (LAN), or the like.

The server device 2 functions as a store server that manages various kinds of information of the store. The server device 2 manages commodity information of items (commodities) sold in the store, for example. The server device 2 manages transaction information for payment processing by the POS terminal 3. Furthermore, the server device 2 manages logo data for a logo to be printed in a header portion of a receipt printed by the receipt printer 4. The server device 2 is an example of the information processing apparatus. The server device 2 may be implemented by a plurality of computers.

One or more POS terminals 3 are installed in the store. The POS terminal 3 controls peripheral devices connected to the POS terminal 3, such as a scanner, a coin machine, and the receipt printer 4. The POS terminal 3 executes payment processing for commodities purchased by a customer. The payment processing is processing for the customer to make a payment to complete a sales transaction or the like. The payment processing executed by the POS terminal 3 includes transmission and reception of information to and from a settlement server in a cashless settlement such as a credit card settlement or a two-dimensional code settlement. The payment processing executed by the POS terminal 3 includes control of the coin machine such as deposit of coins from a customer or payout of coins in a cash settlement.

In the present embodiment, the server device 2 implements processing related to a POS operation, which is executed by a POS terminal itself in the related art, such as information registration of a commodity purchased by a customer (hereinafter, also referred to as “commodity registration”), calculation of a transaction amount for a transaction, and calculation of a coin amount for change due or the like. The server device 2 may implement the processing related to the POS operation as a micro service or a micro service architecture. The POS system 1 of an embodiment is not limited thereto, and the POS terminal 3 in other embodiments may execute a part or all of the processing executed by the server device 2 in the present example.

The POS terminal 3 outputs logo data acquired from the server device 2 to the receipt printer 4. The POS terminal 3 outputs a receipt dispensing instruction to the receipt printer 4 to cause the receipt printer 4 to dispense a receipt.

The POS terminal 3 may be a standard POS terminal at which a store clerk performs operations such as reading a commodity code and settlement of a purchase price, or may be a self-service POS terminal at which a customer performs such operations himself or herself. The POS terminal 3 may be a semi-self-service-type POS terminal including a registration device for the store clerk to perform an operation of reading the commodity code and a separate payment device for the customer to perform an operation of paying the purchase price.

The receipt printers 4 correspond to POS terminals 3 on a one-to-one basis in this example. The receipt printer 4 prints and dispenses a receipt according to an instruction from the corresponding POS terminal 3. The receipt printer 4 stores default header logo data 41 and default footer logo data 42.

The default header logo data 41 is image data printed in the header portion of the receipt. The default header logo data 41 includes, for example, an image of a stylized store name. The default header logo data 41 is printed in the header portion of the receipt when the receipt printer 4 does not receive any other logo data for the header portion in conjunction with the print instruction from the POS terminal 3.

The default footer logo data 42 is image data printed in a footer portion of the receipt. The default footer logo data 42 includes, for example, information such as a store address, a telephone number, and a uniform resource locator (URL) of a home page. In the present embodiment, the receipt printer 4 always prints the default footer logo data 42 in the footer portion of the receipt, but in other examples where logo data for the footer portion is received from the POS terminal 3, the received logo data may be printed in the footer portion. A part or all of the information of the default footer logo data 42 may be included in the default header logo data 41. In this case, a part or all of the information of the default footer logo data 42 may be printed in the header portion of the receipt.

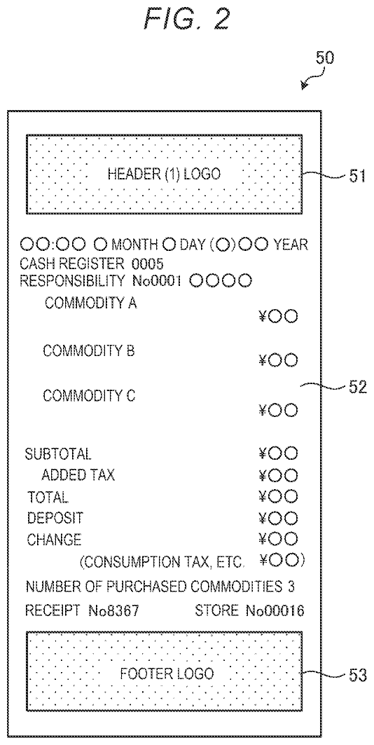

Here, a receipt dispensed by the receipt printer 4 will be described. FIG. 2 is a diagram showing a receipt 50 dispensed by the receipt printer 4. The receipt 50 is a receipt printed when the receipt printer 4 does not receive logo data for the header portion accompanying the print instruction from the POS terminal 3.

The receipt 50 includes a header portion 51, a transaction information field 52, and a footer portion 53. The default header logo data 41 is printed in the header portion 51. In the transaction information field 52, a transaction date and time, the number of the POS terminal 3 that performed payment processing, a name of a store clerk who operated the POS terminal 3, commodity information (a commodity name, a price, etc.) of a transaction commodity, a subtotal amount, an added tax amount, a total amount, a deposit (tendered) amount from a customer, a change amount, the total number of purchased commodities, a receipt number, a store number, and the like are printed. The example in FIG. 2 shows a receipt for a cash-settled transaction. In the receipt of a transaction settled by a cashless settlement, information related to a settlement operator is printed in the transaction information field 52. The default footer logo data 42 is printed in the footer portion 53.

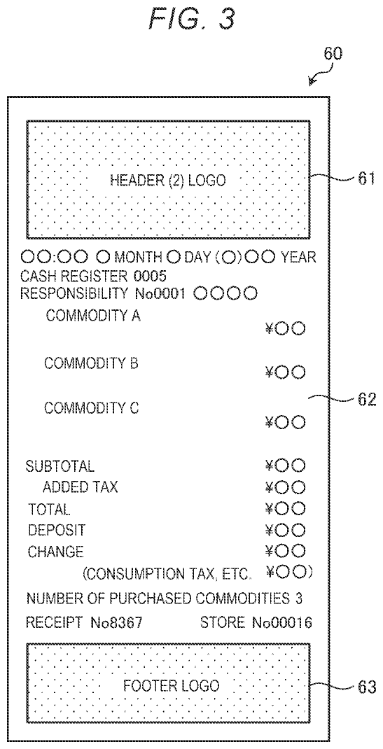

FIG. 3 is a diagram showing a receipt 60 dispensed by the receipt printer 4. The receipt 60 is a receipt printed when the receipt printer 4 receives logo data for the header portion accompanying the print instruction from the POS terminal 3. The logo data received by the receipt printer 4 is first logo data including information indicating a store name and additional information related to a commodity purchased by a customer (hereinafter, also referred to as a “purchased commodity”), or second logo data including information indicating a store name and information related to a marketing/promotional plan to be (or being) implemented by a store.

Here, the additional information related to the purchased commodity includes an advertisement related particularly to the purchased commodity, a logo mark associated with the purchased commodity, an advertisement for a commodity related to the purchased commodity, an image of an advertising character (e.g., a cartoon figure) associated with the purchased commodity, and the like. A commodity related to the purchased commodity is, for example, a rinse or conditioner when the purchased commodity is a shampoo. For example, a related commodity may be typically used as a set with the purchased commodity. The first logo data can be different for different purchased commodities, and a plurality of pieces of first logo data may be prepared. The information related to the marketing or promotional plan to be implemented by the store includes information indicating a type for the plan and an implementation period for the plan. For example, the plan in this context may be a bargain sale plan, a plan for selling a special commodity which is not sold normally, or a clearance sale.

The receipt 60 includes a header portion 61, a transaction information field 62, and a footer portion 63. The first logo data or the second logo data is printed in the header portion 61. A size of the header portion 61 varies according to the first logo data or second logo data to be printed. The size of the header portion 61 may be set to be the same as a size of the header portion 51. In this case, the first logo data or the second logo data to be printed can be enlarged or reduced according to the fixed size of header portion 61. In the transaction information field 62, the information the same as that in the transaction information field 52 in FIG. 2 is printed. The default footer logo data 42 is printed in the footer portion 63.

When the commodity purchased by the customer includes a commodity associated with the first logo data, the receipt printer 4 prints, in the header portion, the first logo data acquired from the server device 2 via the POS terminal 3. When a plurality of purchased commodities associated with the first logo data are included in one transaction, the receipt printer 4 prints the first logo data selected by the server device 2. The server device 2 selects the first logo data according to a priority order set in advance for the first logo data.

When a transaction date of the transaction falls within a plan notification period associated with the second logo data, the receipt printer 4 prints the second logo data acquired from the server device 2 via the POS terminal 3. In the following description, the second logo data corresponding to the plan notification period within which the transaction date falls may be referred to as a “second logo data corresponding to the transaction date”. In the present embodiment, the marketing plans are staggered such that there is one only piece of second logo data corresponding to the transaction date, but, in other examples, there may be a plurality of pieces of second logo data corresponding to the same transaction date. In such a case, the server device 2 may select the particular second logo data according to a priority order set in advance for the different pieces of second logo data.

When items (commodities) purchased by the customer include a commodity associated with the first logo data and the transaction date falls within the plan notification period associated with the second logo data, the receipt printer 4 prints the first logo data or the second logo data as selected by the server device 2. The server device 2 selects between the first logo data or the second logo data according to a priority flag set in advance in the second logo data.

Specifically, when the priority flag set in the second logo data corresponding to the transaction date is “1”, the server device 2 selects the second logo data instead of the first logo data. When the priority flag set in the second logo data corresponding to the transaction date is “0”, the server device 2 selects the first logo data instead of the second logo data. The priority flag can be freely set by the store.

In the present embodiment, when there are a plurality of pieces of first logo data and second logo data to be output as described above, the server device 2 selects one piece of logo data, but may select a plurality of pieces of logo data. In this case, a plurality of pieces of logo data are printed in the header portion 61 of the receipt 60.

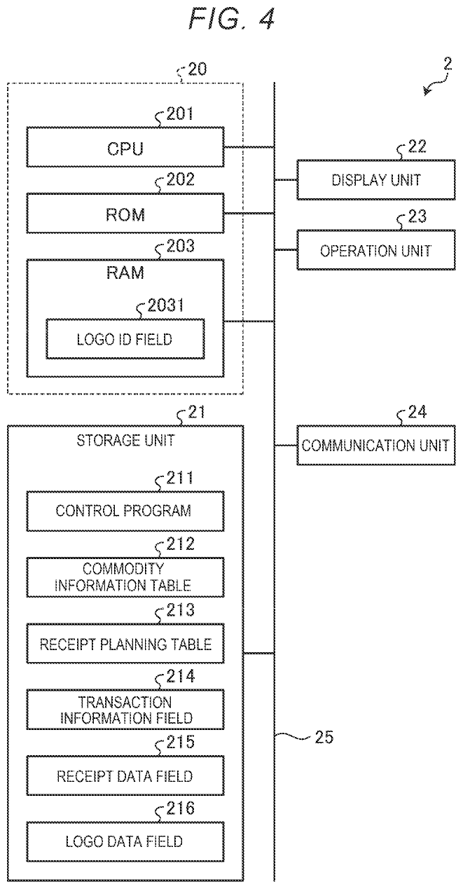

FIG. 4 is a block diagram showing a hardware configuration of the server device 2. The server device 2 includes a control unit 20, a storage unit 21, a display unit 22, an operation unit 23, and a communication unit 24. The control unit 20, the storage unit 21, the display unit 22, the operation unit 23, and the communication unit 24 are connected to each other via a bus 25 or the like.

The control unit 20 has a computer configuration including a central processing unit (CPU) 201, a read only memory (ROM) 202, and a random access memory (RAM) 203. The CPU 201, the ROM 202, and the RAM 203 are connected to each other via the bus 25.

The CPU 201 controls an overall operation of the server device 2. The ROM 202 stores various programs such as a program used for driving the CPU 201 and various pieces of data. The RAM 203 is used as a work area of the CPU 201, and loads various programs and various pieces of data stored in the ROM 202 and the storage unit 21. The control unit 20 executes various types of control processing of the server device 2 by the CPU 201 operating according to control programs stored in the ROM 202 and the storage unit 21 and loaded into the RAM 203.

The RAM 203 includes a logo ID field 2031. The logo ID field 2031 stores a logo ID of the first logo data associated with the purchased commodity in one transaction and a logo ID of the second logo data associated with the transaction date of the one transaction. In other words, the logo ID field 2031 stores the logo ID of the logo data that is a candidate to be printed in the header portion of the receipt in one transaction.

The storage unit 21 is implemented by a storage medium such as a hard disk drive (HDD) or a flash memory, and maintains a storage content even when a power supply is cut off. The storage unit 21 stores a control program 211, a commodity information table 212, a receipt planning table 213, a transaction information field 214, a receipt data field 215, and a logo data field 216.

The control program 211 is a software program for providing a micro service to the POS terminal 3. For example, the control program 211 is a program for acquiring a commodity code from the POS terminal 3 and registering the commodity in a transaction, a software program for calculating a total amount (a transaction amount) due for a transaction settlement and a change due amount for a cash settlement of a transaction, a software program for managing the first logo data and second logo data, a software program for selecting the logo data to be printed on the receipt one of a transaction, and/or a software program for outputting the selected logo data to the POS terminal 3.

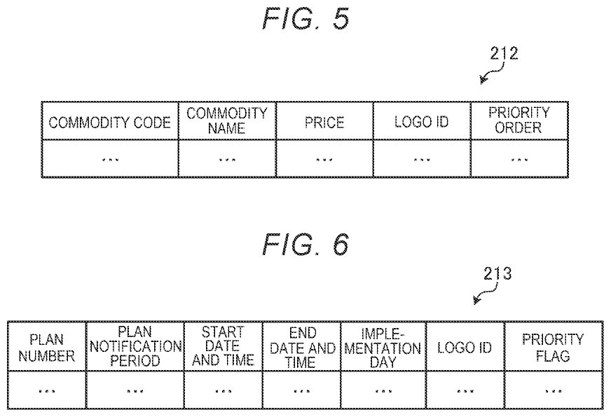

The commodity information table 212 is a master file that stores commodity information of a commodity sold in the store. Since the commodity sold in the store changes daily, the commodity information table 212 is updated as appropriate. FIG. 5 is a diagram showing a data configuration of the commodity information table 212. The commodity information table 212 stores a commodity name, a price, a logo ID, and a priority order in association with the commodity code.

The commodity code field is for information that identifies a commodity and is an example of the commodity identification information. The commodity name field is for information indicating a commodity name. The price field is field information indicating a commodity price. The logo ID field is for information that identifies the logo data to be printed in the header portion of the receipt. The logo ID registered (stored) in the commodity information table 212 is the logo ID of the first logo data. In the present embodiment, the first logo data is associated only with some commodities, so that the logo ID corresponding to every commodity code might not be registered for every commodity. In some examples, logo data may be associated with every one of the commodities.

The priority order field is for information indicating a priority order for selecting the first logo data to be printed in the header portion of the receipt when a plurality of commodities associated with logo IDs are purchased in one transaction. The priority order is set for all the commodities associated with the first logo data, that is, all the commodities whose logo IDs are registered in the commodity information table 212. It can also be said that the priority order in the commodity information table 212 is the priority order of the first logo data.

The receipt planning table 213 is a table that manages the plan implemented by the store. The receipt planning table 213 can be freely updated by the store. FIG. 6 is a diagram showing a data configuration of the receipt planning table 213. The receipt planning table 213 stores a plan notification period, a start date and time, an end date and time, an implementation day, a logo ID, and a priority flag in association with a plan number (plan ID).

The plan number is a number that specifies a specific promotional plan, marketing campaign, or the like planned for the store. The plan notification period is information that defines the period during which information related to the plan will be printed in the header portion of the receipt. For example, a bargain sale plan is scheduled for a particular date or date range in the future, then the one week period before the start for the bargain sale plan up to the day before the start date of the bargain sale period is registered as the plan notification period. When a transaction date of a certain transaction falls within the plan notification period, the control unit 20 extracts the second logo data identified by the corresponding logo ID as a candidate for the logo data to be printed in the header portion of the receipt related to the transaction.

The start date and time field is for information indicating a start date and time of the plan. The end date and time field is for information indicating an end date and time of the plan. The implementation day field is for information indicating a day on which the plan is implemented. The logo ID field is for information that identifies the logo data to be printed in the header portion of the receipt in association with the plan. The logo ID registered in the receipt planning table 213 is a logo ID of second logo data.

The priority flag is information indicating whether to prioritize the second logo data when the first logo data and the second logo data are both extracted as candidates for the logo data to be printed in the header portion of the receipt. When “1” is registered in the priority flag, the particular second logo data has priority over the first logo data. When “0” is registered in the priority flag, the first logo data has priority over the second logo data.

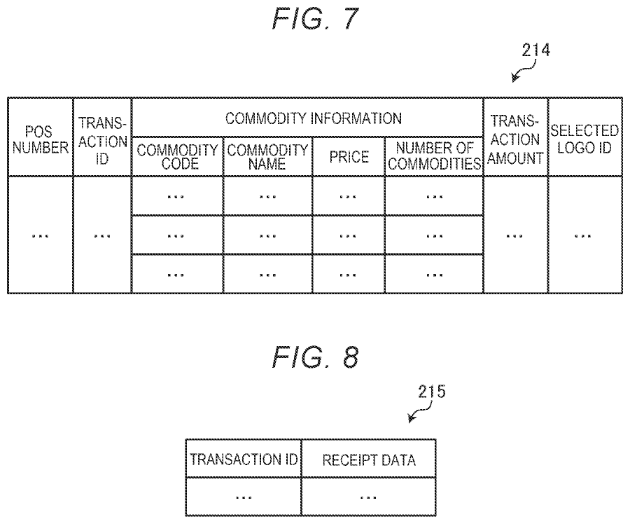

The transaction information field 214 tracks transaction information for each transaction. The transaction information field 214 is updated as needed based on information supplied from the POS terminal 3. FIG. 7 is a diagram showing a data configuration of the transaction information field 214. The transaction information field 214 stores a transaction ID, commodity information, a transaction amount, and a selection logo ID in association with a POS number.

The POS number is a number that specifies one of the plurality of POS terminals 3. The POS number specifies the POS terminal 3 that transmits the commodity code(s) to the server device 2 for the particular transaction (transaction ID). The POS number is registered, for example, when the server device 2 first receives a commodity code and a POS number from the POS terminal 3 in a transaction. The transaction ID is identification information that uniquely identifies a transaction. The transaction ID can be dispensed and registered by the server device 2, for example, when the POS number is registered.

The commodity information is information related to a commodity in the transaction, and includes a commodity code, a commodity name, a price, and the number of commodities. The commodity code, the commodity name, and the price is as described above, and redundant description is omitted here. The number of commodities is information indicating the number of registered commodities being purchased by the customer. The transaction amount is information indicating a total amount (cost) of the items for a transaction. As the transaction amount, for example, when the server device 2 receives a payment instruction from the POS terminal 3, a transaction amount calculated by the server device 2 is registered.

The selected logo ID is the logo ID of first logo data or second logo data as selected by the server device 2. When neither the logo ID of the first logo data nor the logo ID of the second logo data is selected by the server device 2, information indicating that there is no selected logo ID can be registered in the selected logo ID item.

The receipt data field 215 manages the receipt data generated by the server device 2 for each transaction ID. FIG. 8 shows a data configuration of the receipt data field 215. The receipt data field 215 stores the transaction ID and the receipt data in association with each other.

The transaction ID is information that identifies the transaction as described above. The receipt data is data printed in the transaction information field 52 of the receipt shown in FIG. 2 or the transaction information field 62 of the receipt shown in FIG. 3. The receipt data is generated and stored in a data format printable by the receipt printer 4.

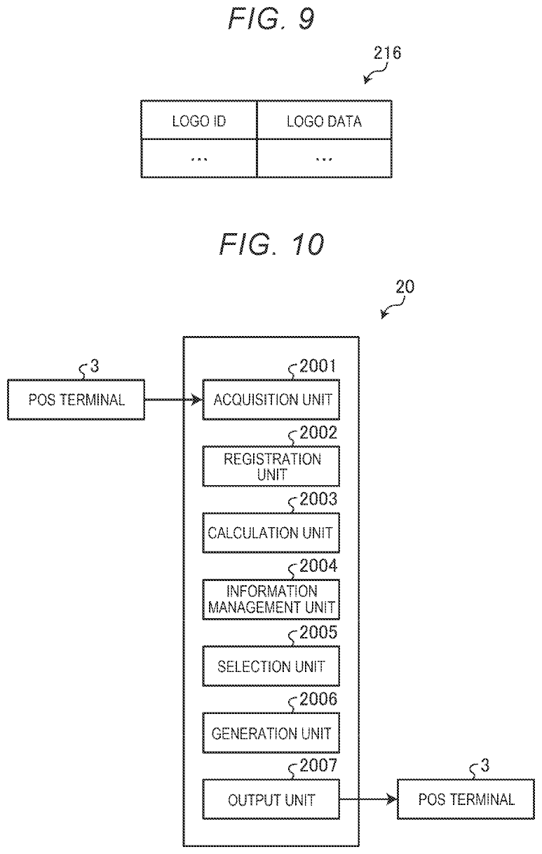

The logo data field 216 manages the first logo data and the second logo data. FIG. 9 is a diagram showing a data configuration of the logo data field 216. The logo data field 216 stores the logo ID and the logo data in association with each other.

The logo ID is information that identifies the first logo data or the second logo data. The logo data can be either the first logo data or the second logo data. In this context, first logo data is image data including information indicating a store name and additional information related to a commodity. Second logo data is image data including information indicating a store name and information related to a marketing plan implemented by the store. The information indicating the store name is an example of information indicating a business operator who sells a commodity. A company name, a company mark (a house mark), a store-specific mark, or the like may be used as the information indicating the business operator.

Referring back to FIG. 4, the hardware configuration of the server device 2 will be described.

The display unit 22 is a display device and includes a liquid crystal display or the like. The display unit 22 displays various kinds of information under the control of the control unit 20. For example, the display unit 22 displays a registration screen for manually registering information in the commodity information table 212, the receipt planning table 213, and the like.

The operation unit 23 is an input device and may include a keyboard and the like for user/operator input operations. The operation unit 23 inputs, to the control unit 20, various kinds of information input by a user who controls the server device 2. For example, the operation unit 23 inputs, to the control unit 20, information for updating the commodity information table 212, the receipt planning table 213, and the like.

The communication unit 24 is an interface for communicating with an external device such as a POS terminal 3. The control unit 20 can transmit and receive information (data) to and from the external device by being connected to the external device via the communication unit 24.

Next, certain functional aspects of the control unit 20 of the server device 2 will be described. FIG. 10 is a block diagram depicting functional units of the control unit 20. The control unit 20 functions as an acquisition unit 2001, a registration unit 2002, a calculation unit 2003, an information management unit 2004, a selection unit 2005, a generation unit 2006, and an output unit 2007 by the CPU 201 operating according to the control program stored in the ROM 202 or the storage unit 21. The various described functions may be implemented by using hardware such as a dedicated circuit.

The acquisition unit 2001 acquires the commodity identification information for identifying the commodity. Specifically, the acquisition unit 2001 receives the commodity code input to the POS terminal 3 from the POS terminal 3. The commodity code read by the scanner that is connected to the POS terminal 3 is input to the POS terminal 3. The acquisition unit 2001 acquires the commodity code every time the commodity code is input to the POS terminal 3.

The registration unit 2002 registers the commodity information of the commodity identified by the commodity identification information acquired by the acquisition unit 2001. Specifically, the registration unit 2002 reads out, from the commodity information table 212, the commodity information corresponding to the commodity code acquired by the acquisition unit 2001. The registration unit 2002 registers the commodity code, the commodity name, the unit price, and the number of commodities in the transaction information field 214 to execute the commodity registration.

The calculation unit 2003 calculates the amount of money for settlement of the transaction. For example, the calculation unit 2003 calculates the transaction amount of a transaction in response to the payment instruction from the POS terminal 3. The calculation unit 2003 calculates a transaction amount based on the commodity information registered in the transaction information field 214. When a cash settlement is made at the POS terminal 3, the calculation unit 2003 calculates the change amount (change due) in response to a request from the POS terminal 3.

The information management unit 2004 manages various kinds of information such as information related to logo data. Here, managing information means writing or reading out various kinds of information (data) in to or from the storage unit 21.

For example, the information management unit 2004 manages the first logo data which is the image data printed in the header portion of the receipt indicating commodity information registered by the registration unit 2002 in a transaction, is associated with the commodity identification information acquired by the acquisition unit 2001, and includes the information indicating the business operator who sells the commodity and the additional information related to the commodity. Specifically, the information management unit 2004 writes the logo ID of the first logo data and the logo data in the commodity information table 212, the transaction information field 214, and the logo data field 216. The information management unit 2004 reads out the logo ID of the first logo data and the logo data from the commodity information table 212, the transaction information field 214, and the logo data field 216.

When there are multiple pieces of first logo data corresponding to the commodity identification information acquired by the acquisition unit 2001, the information management unit 2004 stores the priority order for the selection unit 2005 to select the first logo data to be used. Specifically, the information management unit 2004 writes the information in the priority order item of the commodity information table 212 according to the information input from the operation unit 23.

The information management unit 2004 manages the second logo data which is the image data indicated in the header portion of the receipt and includes the information indicating the business operator who sells a commodity and the information related to a marketing or promotional plan implemented by the business (store) operator. Specifically, the information management unit 2004 writes the logo ID of the second logo data and the logo data in the receipt planning table 213, the transaction information field 214, and the logo data field 216. The information management unit 2004 reads out the logo ID of the second logo data and the logo data from the receipt planning table 213, the transaction information field 214, and the logo data field 216.

The information management unit 2004 stores information indicating whether the selection unit 2005 is to select the second logo data in preference to the first logo data in association with the second logo data. Specifically, the information management unit 2004 writes the information in the priority flag item of the receipt planning table 213 according to the information input from the operation unit 23.

The information management unit 2004 writes the logo ID in the logo ID field 2031. For example, the information management unit 2004 reads out the logo ID corresponding to a commodity code acquired by the acquisition unit 2001 from the commodity information table 212 and stores the logo ID in the logo ID field 2031. The information management unit 2004 reads out the logo ID corresponding to the transaction date from the receipt planning table 213 and stores a logo ID in the logo ID field 2031.

The selection unit 2005 selects the first logo data based on the commodity identification information acquired by the acquisition unit 2001. Specifically, the selection unit 2005 refers to the commodity information table 212 and selects the logo ID corresponding to the commodity code acquired by the acquisition unit 2001. The selection unit 2005 selects the first logo data corresponding to the read logo ID in the logo data field 216.

The selection unit 2005 selects either the first logo data or the second logo data as managed by the information management unit 2004. More specifically, the selection unit 2005 selects either the first logo data or the second logo data from the logo data stored in the logo ID field 2031 as the logo data to be output to the POS terminal 3. The selection unit 2005 selects either the first logo data or the second logo data based on the priority order registered in the commodity information table 212 and the priority flag registered in the receipt planning table 213.

When there is no first logo data corresponding to a commodity code acquired by the acquisition unit 2001 or any second logo data corresponding to the transaction date, the selection unit 2005 does not select the logo data to be output to the POS terminal 3.

The generation unit 2006 generates receipt data. The generation unit 2006 generates the receipt data based on the transaction information stored in the transaction information field 214 in response to a receipt data request from the POS terminal 3. The receipt data generated by the generation unit 2006 has a data format printable by the receipt printer 4.

The output unit 2007 outputs, to the POS terminal 3, either the first logo data or the second logo data as selected by the selection unit 2005. When the selection unit 2005 does not select either first logo data or the second logo data, the output unit 2007 outputs information to the POS terminal 3 indicating that there is no specifically selected logo data. In this case, the POS terminal 3 outputs an instruction to the receipt printer 4 to print the default header logo data 41 in the header portion.

When an electronic receipt is used as the receipt, the output unit 2007 may similarly output either the first logo data or the second logo data as selected by the selection unit 2005 to the electronic receipt server. The electronic receipt server transmits, to a portable terminal of the customer, an electronic receipt in which the logo data output by the output unit 2007 is written in the header portion. When the selection unit 2005 does not select either the first logo data or the second logo data, the output unit 2007 outputs information indicating that there is no selected logo data to the electronic receipt server. In this case, the electronic receipt server dispenses an electronic receipt using predetermined default header logo data.

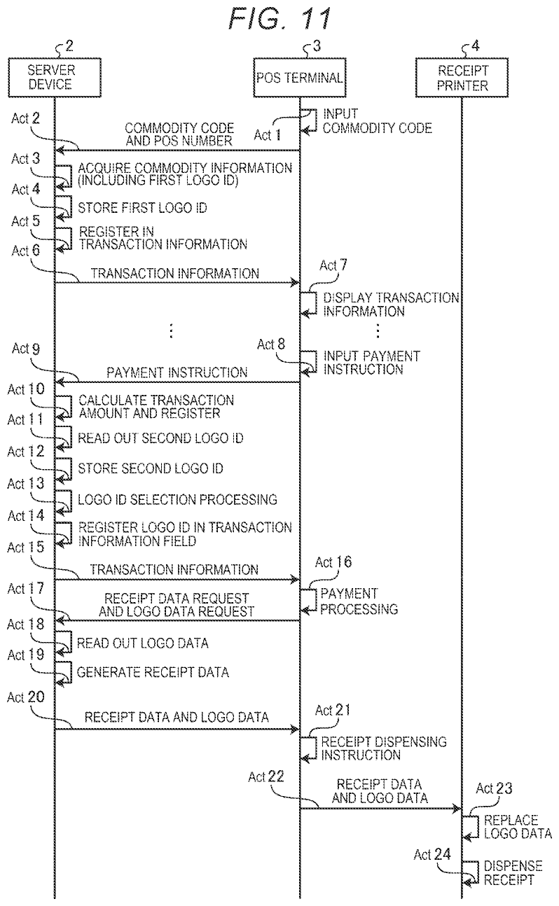

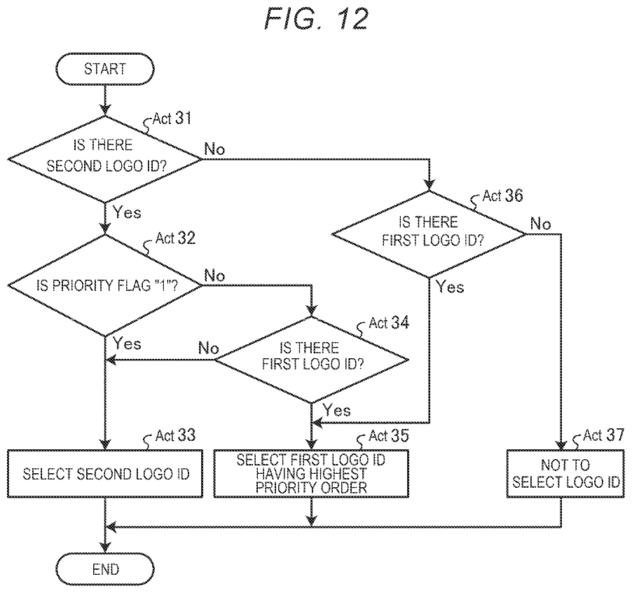

FIG. 11 is a sequence chart showing an operation flow of the POS system 1. The sequence chart shows example operations when there is first logo data corresponding to the commodity codes acquired by the acquisition unit 2001 and second logo data corresponding to the transaction date.

After transaction start input, the commodity code is input to the POS terminal 3 from, for example, a scanner (Act 1). The POS terminal 3 transmits the input commodity code and the POS number of the POS terminal 3 to the server device 2 (Act 2). In the following operations, when the POS terminal 3 transmits any information to the server device 2, the POS number of the POS terminal 3 is also usually transmitted. The server device 2 specifies the POS terminal 3 as an information transmission destination based on the received POS number.

The server device 2 acquires commodity information corresponding to the received commodity code (Act 3). Specifically, the server device 2 reads out the commodity information corresponding to the received commodity code from the commodity information table 212. The commodity information in this example includes a logo ID of the first logo data (hereinafter, also referred to as a “first logo ID”). The server device 2 stores, in the logo ID field 2031, the first logo ID from the read commodity information (Act 4).

The server device 2 registers the read commodity information and the received POS number in the transaction information field 214 in association with each other (Act 5). In other words, the server device 2 performs a commodity registration. The server device 2 transmits transaction information including the registered commodity information to the POS terminal 3 (Act 6). The server device 2 transmits the transaction information to the POS terminal 3.

The POS terminal 3 displays the received transaction information (Act 7). Accordingly, the store clerk or the customer can check the commodity information of the purchased commodity. When multiple commodities are purchased by the customer in the same transaction, the operations of Acts 1 to 7 are repeated for each commodity to be registered. When the commodity registration of all the commodities to be purchased by the customer is completed, a payment instruction is input to the POS terminal 3 (Act 8). The POS terminal 3 transmits the payment instruction to the server device 2 (Act 9).

Based on the transaction ID included in the received payment instruction, the server device 2 calculates the transaction amount for the transaction ID, and registers the transaction amount in the transaction information field 214 (Act 10). Specifically, the server device 2 reads out the commodity information corresponding to the received transaction ID from the transaction information field 214 and calculates the transaction amount. Then, the server device 2 registers the calculated transaction amount in the transaction information field 214.

The server device 2 also reads out a logo ID of second logo data (hereinafter, also referred to as a “second logo ID”) from the receipt planning table 213 (Act 11). The server device 2 recognizes the transaction date by a real time clock (RTC) unit or the like that tracks the current date and time, and reads out, from the receipt planning table 213, a second logo ID corresponding to the plan notification period within which the present transaction date falls. The server device 2 stores the read second logo ID in the logo ID field 2031 (Act 12).

The server device 2 then executes logo ID selection processing for selecting the logo ID to be transmitted to the POS terminal 3 from the first logo ID and the second logo ID stored in the logo ID field 2031 (Act 13). The server device 2 registers the logo ID selected in the logo ID selection processing in the transaction information field 214 and updates the transaction information (Act 14). The server device 2 transmits the updated transaction information to the POS terminal 3 (Act 15).

The POS terminal 3 handles payment processing based on the received transaction information (Act 16). The POS terminal 3 transmits and receives information to and from the server device 2 as necessary in the payment processing. For example, the POS terminal 3 transmits a calculation request for the change due amount to the server device 2 and receives the calculated change due from the server device 2.

The POS terminal 3 ultimately transmits a receipt data request and a logo data request to the server device 2 (Act 17). The receipt data request is for requesting receipt data to be transmitted from the POS terminal 3 to the receipt printer 4. The logo data request is for requesting the presence or absence of logo data to be transmitted from the POS terminal 3 to the receipt printer 4 and, if there is logo data to be transmitted, the logo data.

The server device 2 reads out, from the logo data field 216, the selected logo data, that is, the logo data identified by the selected logo ID registered in the transaction information field 214 (Act 18). The server device 2 generates the receipt data based on the transaction information specified by the transaction ID included in the received receipt data request (Act 19). The server device 2 transmits the read logo data and the generated receipt data to the POS terminal 3 (Act 20).

The receipt dispensing instruction is input to the POS terminal 3 (Act 21). The receipt dispensing instruction is input, for example, by operating a closing key for declaring the end of a transaction. The POS terminal 3 transmits, to the receipt printer 4, the receipt dispensing instruction including the receipt data and the logo data (Act 22).

The receipt printer 4 replaces the logo data to be printed in the header portion of the receipt with the logo data received from the default header logo data 41 (Act 23). In other words, the receipt printer 4 uses the received logo data instead of the stored default header logo data 41 as the logo data to be printed in the header portion of the receipt. Then, the receipt printer 4 dispenses a receipt by printing using the replaced logo data (Act 24).

With the above operations, the POS system 1 can appropriately change the logo data to be printed in the header portion of the receipt printed by the receipt printer 4.

FIG. 12 is a flowchart showing a flow of the logo ID selection processing by the control unit 20 of the server device 2.

The selection unit 2005 determines whether the second logo ID is stored in the logo ID field 2031 (Act 31). In other words, the selection unit 2005 determines whether there is second logo data for replacing the default header logo data 41. If the second logo ID is stored in the logo ID field 2031 (Y in Act 31), the selection unit 2005 next determines whether the priority flag of the second logo ID is “1” (Act 32). Specifically, the selection unit 2005 determines whether the priority flag corresponding to the second logo ID read out from the receipt planning table 213 by the information management unit 2004 is “1”.

When the priority flag of the second logo ID is “1” (Y in Act 32), the selection unit 2005 selects the second logo ID as the logo ID to be output to the POS terminal 3 (Act 33). Then, the control unit 20 ends the logo ID selection processing.

In the processing in Act 32, when the priority flag of the second logo ID stored in the logo ID field 2031 is “0” (N in Act 32), the selection unit 2005 next determines whether a first logo ID is stored in the logo ID field 2031 (Act 34). When the first logo ID is not stored in the logo ID field 2031 (N in Act 34), the control unit 20 proceeds to processing in Act 33.

When a first logo ID is stored in the logo ID field 2031 (Y in Act 34), the selection unit 2005 then selects the first logo ID having the highest priority order among the first logo IDs stored in the logo ID field 2031 (Act 35). The selection unit 2005 refers to the commodity information table 212 and selects the first logo ID having the highest priority order as the logo ID of the logo data to be output to the POS terminal 3. Then, the control unit 20 ends the logo ID selection processing.

In the processing in Act 31, when the second logo ID is not stored in the logo ID field 2031 (N in Act 31), the selection unit 2005 next determines whether the first logo ID is stored in the logo ID field 2031 (Act 36). When a first logo ID is stored in the logo ID field 2031 (Y in Act 36), the control unit 20 proceeds to processing in Act 35.

When the first logo ID is not stored in the logo ID field 2031 (N in Act 36), the selection unit 2005 does not select a logo ID to be output to the POS terminal 3 (Act 37). In other words, when neither the first logo ID nor the second logo ID is stored in the logo ID field 2031, the selection unit 2005 determines that there is no special logo data to be output to the POS terminal 3. Then, the control unit 20 ends the logo ID selection processing.

When the selection unit 2005 determines that there is no logo data to be output to the POS terminal 3, the default header logo data 41 is printed in a default portion of the receipt. In other words, when the receipt printer 4 receives a receipt dispensing instruction not including the logo data, the receipt printer 4 controls a print unit to print the default header logo data 41 in the header portion of the receipt.

Through the logo ID selection processing, the control unit 20 can determine the presence or absence of the logo data to be output to the POS terminal 3 for one transaction. When there is logo data to be output, the control unit 20 can select the logo ID of the logo data.

As described above, the server device 2 according to the embodiment includes an acquisition unit 2001 configured to acquire a commodity code for identifying a commodity; a registration unit 2002 configured to register commodity information of the commodity identified by the commodity code acquired by the acquisition unit 2001; an information management unit 2004 configured to manage first logo data which is image data indicated in a header portion of a receipt indicating the commodity information registered by the registration unit 2002 in a transaction, is associated with the commodity identification information acquired by the acquisition unit 2001, and includes information indicating a store name and additional information related to the commodity; a selection unit 2005 configured to select the first logo data based on the commodity code acquired by the acquisition unit 2001; and an output unit 2007 configured to output the first logo data selected by the selection unit 2005.

Accordingly, the server device 2 can set the store name and additional information associated with a purchased commodity or the like, which may be information the store considers will promote sales or the like, in the logo data printed in the header portion of the receipt. Therefore, the store can more effectively use the header portion of the receipt that the customers typically focuses on when looking at receipts.

The information management unit 2004 of the server device 2 according to an embodiment stores the priority order for the selection unit 2005 to select a piece of the first logo data when there are a plurality of pieces of first logo data corresponding to the commodity codes acquired by the acquisition unit 2001.

Accordingly, the server device 2 can appropriately select first logo data even when a plurality of commodities are purchased in one transaction.

The information management unit 2004 of the server device 2 also manages second logo data which is image data for the header portion of the receipt and includes information indicating a store name and information related to a marketing plan implemented by the business/store operator.

Accordingly, the server device 2 can also set as the logo data to be printed in the header portion of the receipt the store name and the information related to the marketing plan of the store, which is information the store uses to attract the customer or promote sales.

In addition, the selection unit 2005 of the server device 2 selects either the first logo data or the second logo data managed by the information management unit 2004, and the output unit 2007 outputs the first logo data or the second logo data selected by the selection unit 2005.

Accordingly, the server device 2 can set the first logo data including the store name and the additional information of the purchased commodity, or the second logo data including the store name and the information related to the marketing plan of the store, as logo data to be selectively printed in the header portion of the receipt.

The information management unit 2004 of the server device 2 according to the embodiment stores information indicating whether the selection unit 2005 selects the second logo data in preference to the first logo data in association with the second logo data.

Accordingly, when the first logo data and the second logo data are to be output by the output unit 2007, the server device 2 can set whether to preferentially output the first logo data or the second logo data. Therefore, store operations related to the selection of logo data to be printed in the header portion of the receipt can be facilitated.

In an embodiment, the control program executed by the server device 2 may be provided by being recorded on a non-transitory computer-readable recording medium such as a CD-ROM. The control program executed by server device 2 may be stored in a computer connected to a network such as the Internet and be provided by being downloaded via the network, or may be accessed via the network such as the Internet.

In an embodiment, the server device 2 implements, as a micro service, processing related to a POS operation, which might otherwise be executed by a POS terminal itself in other examples. In this context, a POS operation is processing such as information registration of a commodity being purchased by a customer, calculation of a transaction amount for a transaction, and calculation of a change back amount. However, the POS system 1 is not limited thereto, and the POS terminal 3 in some examples may execute a part or all of the processing described above as executed by the server device 2. In this case, the hardware that implements a part or all of the processing otherwise described as executed by the server device 2 can be provided by the POS terminal 3 utilizing the existing hardware of the POS terminal 3 or by incorporation of a part or all of the hardware configuration of the server device 2 as described with reference to FIG. 4.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing apparatus for point-of-sale systems, the apparatus comprising:
a storage unit for storing first logo data associated with commodities;
a communication interface configured to connect to a point-of-sale terminal; and
a processor configured to:
acquire commodity identification information for a commodity from the point-of-sale terminal via the communication interface;
register commodity information for the commodity identified by the acquired commodity identification information in a sales transaction;
select a piece of first logo data from the storage unit based on the registered commodity information in the sales transaction; and
output the selected piece of first logo data to the point-of-sale terminal via the communication information for inclusion in a header portion of a transaction receipt provided by the point-of-sale terminal for the sales transaction.

2. The information processing apparatus according to claim 1, wherein
each piece of first logo data is associated with a priority order value, and
the processor selects the piece of first logo data from the storage unit based on priority order value when a plurality of commodities are registered in the sales transaction.

3. The information processing apparatus according to claim 1, wherein
the storage unit additionally stores second logo data associated with promotional campaign conditions,
the processor is further configured to output second logo data to the point-of-sale terminal via the communication interface when the sales transaction meets the promotional campaign conditions, and
the second logo data for inclusion in the header portion of the transaction receipt provided by the point-of-sale terminal for the sales transaction.

4. An information processing apparatus for point-of-sale systems, the apparatus comprising:
a storage unit for storing first logo data associated with commodities and second logo data associated with a planned promotional event;
a communication interface configured to connect to a point-of-sale terminal; and
a processor configured to:
acquire commodity identification information for a commodity from the point-of-sale terminal via the communication interface;
register commodity information for the commodity identified by the acquired commodity identification information in a sales transaction;
select either a piece of first logo data from the storage unit based on the registered commodity information in the sales transaction or a piece of second logo data based on promotional campaign conditions; and
output the selected piece of first or second logo data to the point-of-sale terminal via the communication information for inclusion in a header portion of a transaction receipt provided by the point-of-sale terminal for the sales transaction.

5. The information processing apparatus according to claim 4, wherein
each piece of first logo data is associated with a priority order value, and
the processor selects between the pieces of first logo data from the storage unit based on priority order values when a plurality of commodities are registered in the sales transaction.

6. The information processing apparatus according to claim 5, wherein
each piece of second logo data is associated with a priority flag value, and
the processor selects the second logo data when the priority flag value indicates a priority of the second logo data over the first logo data.

7. The information processing apparatus according to claim 4, wherein
each piece of second logo data is associated with a priority flag value, and
the processor selects the second logo data when the priority flag value indicates a priority of the second logo data over the first logo data.

8. A point-of-sale system, comprising:
an information processing apparatus according to claim 4;
a plurality of point-of-sale terminals connected to the information processing apparatus; and
a receipt printer connected to at least one point-of-sale terminal in the plurality of point-of-sale terminals.

9. An information processing method for promotional receipt header generation for point-of-sale systems for retail stores, the method comprising:
storing first logo data associated with commodities and second logo data associated with a planned promotional event in a storage unit;
acquiring commodity identification information for a commodity from a point-of-sale terminal via a communication interface;
registering commodity information for the commodity identified by the acquired commodity identification information in a sales transaction;
selecting either a piece of first logo data from the storage unit based on the registered commodity information in the sales transaction or a piece of second logo data based on promotional campaign conditions; and
outputting the selected piece of first or second logo data to the point-of-sale terminal via the communication information for inclusion in a header portion of a transaction receipt provided by the point-of-sale terminal for the sales transaction.

10. The method according to claim 9, wherein
each piece of first logo data is associated with a priority order value, and
the pieces of first logo data are selected from the storage unit based on priority order values when a plurality of commodities are registered in the sales transaction.

11. The method according to claim 10, wherein
each piece of second logo data is associated with a priority flag value, and
the second logo data is selected when the priority flag value indicates a priority of the second logo data over the first logo data.

12. The method according to claim 9, wherein
each piece of second logo data is associated with a priority flag value, and
the second logo data is selected when the priority flag value indicates a priority of the second logo data over the first logo data.
